(19) United States
(12) Patent Application Publication
(10) Pub. No.: US 2013/0272752 A1
(43) Pub. Date: Oct. 17, 2013

(54) IMAGE FORMING UNIT AND IMAGE FORMING APPARATUS

(71) Applicant: OKI DATA CORPORATION, TOKYO (JP)

(72) Inventor: Yuki MATSUURA, Tokyo (JP)

(73) Assignee: OKI DATA CORPORATION, TOKYO (JP)

(21) Appl. No.: 13/855,098

(22) Filed: Apr. 2, 2013

(30) Foreign Application Priority Data
Apr. 13, 2012 (JP) 2012-091590

(51) Int. Cl. G03G 15/08

(52) U.S. Cl. CPC G03G 15/0813
USPC 399/274

(57) ABSTRACT

An image forming unit includes an image carrier carrying an electrostatic latent image on a surface thereof; a developer supply member supplying developer; a developer carrier carrying the developer supplied by the developer supply member on a surface thereof; and a developer layer forming member that includes a curvature part having a predetermined curvature radius, abutting the curvature part on the surface of the developer carrier to form a developer layer on the surface. The developer carrier attaches the developer layer to the electrostatic latent image to form a developer image on the surface of the image carrier, and a pressing parameter is within a range of 9.3×10⁻⁷ g·m²/s² or more and 2.3×10⁻⁶ g·m²/s² or less when the pressing parameter is determined by multiplying a linear pressure of the curvature part against the surface of the developer carrier, a square root of the curvature radius, and pi (π).

### CROSS REFERENCE TO RELATED APPLICATION

The present application is related to, claims priority from and incorporates by reference Japanese Patent Application No. 2012-091590, filed on Apr. 13, 2012.

### TECHNICAL FIELD

The present invention relates to technologies to form an image on a recording medium by an electrophotographic process.

### BACKGROUND

An electrophotographic image forming process includes the following consecutive steps: charging a photosensitive body to form a uniformly charged surface of the photosensitive body; exposing the photosensitive body to light to form an electrostatic latent image on the charged surface of the photosensitive body; developing the electrostatic latent image by attaching charged developer to the electrostatic latent image in order to form a developer image on the photosensitive body; transferring the developer image onto a recording medium such as a piece of paper; and fixing the transferred developer image to the recording medium.

In charging, after a thin layer made of charged developer has been formed on a surface of a developer carrier, the thin layer attaches to a surface of the photosensitive body from the developer carrier. Formation of the thin layer made of the developer is performed by abutting a layer forming member such as a plate-like blade and the like on the surface of the developer carrier. The developer is thinned when the developer passes an abutting part between the developer carrier and the layer forming member. It is important to form a stable thin layer made of the developer in order to stabilize a print density, for example. JP Laid-Open Patent Application No. 2002-108089 discloses a development device that includes a plate-like blade (development blade) as a layer forming member. The development blade includes a bended front edge part in which a curvature has a predetermined curvature radius. A curvature part of the development blade abuts on a surface of a development carrier at a predetermined pressure in the development device, and thins developer.

However, with the above structure, image quality might degrade.

One of objections illustrated by the present invention is to improve the image quality.

### SUMMARY

An image forming unit disclosed in the application includes an image carrier configured to carry an electrostatic latent image on a surface thereof; a developer supply member configured to supply developer; a developer carrier configured to carry the developer supplied by the developer supply member on a surface thereof; and a developer layer forming member that includes a curvature part having a predetermined curvature radius, configured to abut the curvature part on the surface of the developer carrier to form a developer layer on the surface of the developer carrier. The developer carrier attaches the developer layer to the electrostatic latent image to form a developer image on the surface of the image carrier, and a pressing parameter is set to be within a range of 9.3×10⁻⁷ g·m²/s² or more and 2.3×10⁻⁶ g·m²/s² or less when the pressing parameter is determined by multiplying a linear pressure of the curvature part against the surface of the developer carrier, a square root of the curvature radius, and pi (π).

In another view, an image forming apparatus disclosed in the application includes the above image forming unit, and a transfer member configured to transfer the developer image formed by the image forming unit onto a recording medium.

In the specific examples illustrated in the present invention, the image quality is improved.

### BRIEF DESCRIPTION OF THE DRAWINGS

In the attached drawings:

FIG. 1 is a schematic diagram of a main structure of an image forming apparatus according to an embodiment of the present invention;

FIG. 2 schematically illustrates a schematic diagram of a structure of an image forming unit of the embodiment;

FIG. 3 schematically illustrates an arrangement of a development roller and a development blade of the embodiment;

FIG. 4 is a schematic configuration diagram of a shaker according to the embodiment used in a first experiment (durability test);

FIG. 5 schematically illustrates a 2×2 image.

FIG. 6 illustrates values of a pressing parameter and evaluation results of the first experiment;

FIG. 7 illustrates values of the pressing parameter and the evaluation results of the first experiment;

FIG. 8 illustrates preferable ranges of the pressing parameter according to the embodiment;

FIG. 9 illustrates measurement results and evaluation results regarding the measurement results of the second experiment(durability test); and

FIG. 10 illustrates the measurement results and the evaluation results regarding the measurement results of the second experiment.

### DESCRIPTION OF EMBODIMENTS

An embodiment of the invention is described below with reference to the attached drawings.

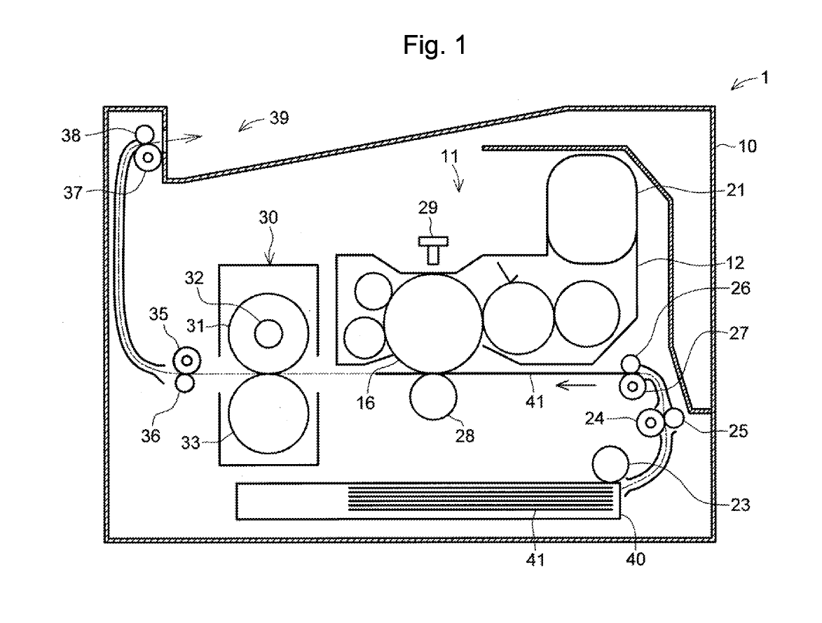

FIG. 1 is a schematic diagram of a main structure of an electrophotographic image forming apparatus 1 of the present embodiment. As illustrated in FIG. 1, the image forming apparatus 1 includes a chassis 10. The image forming apparatus 1 further includes a cassette 40, a carrying mechanism, an image forming unit 11 (a development device), a transfer roller 28 and a fuser 30 in the chassis 10. The cassette 40 accommodates recording mediums 41 . . . 41 to which developer images are to be transferred. The carrying mechanism carries the recording mediums 41. The image forming unit 11 is removal and forms a black developer image. The transfer roller 28 is a transfer member that transfers the developer images onto the recording mediums 41. The fuser 30 fixes the developer images on the recording mediums 41. The carrying mechanism is configured by a hopping roller 23, a carrying roller 24, pinch rollers 25 and 26 and a resist roller 27. The carrying mechanism carries the recording medium 41 into the direction of the image forming unit 11 (direction of a downstream side). The recording medium 41 is carried with stacked on a transfer belt (not illustrated). The carrying mechanism is further configured by ejection rollers 35 and 37, and pinch rollers 36 and 38. The carrying mechanism carries the recording medium 41 from the fuser 30 to a stacker part 39.

The cassette 40 has a function to accommodate a stack of a plurality of the recording mediums 41. The cassette 40 is removably installed to the image forming apparatus 1. Examples of the recording medium 41 are sheet-like objects such as sheet, plastic films, synthetic paper and cloth.

The hopping roller 23 is arranged above the cassette 40 near an ejection opening to which the recording medium is to be fed. The hopping roller 23 picks up and carries each of the recording mediums 41 from the cassette 40 to a space between the pinch roller 25 and the carrying roller 24 on the downstream side of a carrying path. The carrying roller 24 and the pinch roller 25 carry the recording medium 41 to a space between the pinch roller 26 and the resist roller 27 on the downstream side of the carrying path while sandwiching the recording medium 41 sent from the cassette 40. The pinch roller 26 and the resist roller 27 carry the recording medium 41 to a space between the image forming unit 11 and a transfer roller 28 while sandwiching the recording medium 41 and correcting the skew of the recording medium 41. The hopping roller 23, the carrying roller 24 and the resist roller 27 carry the recording medium 41 by rotating in response to a power transmitted from a drive source (not illustrated) through a power transmission mechanism such as a gear and the like.

The image forming unit 11 includes a photosensitive drum 16 as an image carrier. The photosensitive drum 16 carries a developer image on the surface thereof. The transfer roller 28 is arranged at a position in which the transfer roller 28 faces the photosensitive drum 16. The transfer roller 28 is made of a conductive elastic member such as conductive rubber or the like. The recording medium 41 passes a nipping part between the transfer roller 28 and the photosensitive drum 16. The transfer roller 28 is a member that transfers (moves) a developer image on the photosensitive drum 16 to the recording medium 41 at the nipping part. The transfer roller 28 is arranged to apply a pressure to the surface of the photosensitive drum 16 through a transfer belt (not illustrated). A high-voltage power supply (not illustrated) applies a voltage to the transfer roller 28. The voltage provides a difference in potential between the surface of the photosensitive drum 16 and the surface of the transfer roller 28 when the developer image is transferred.

The fuser 30 performs carries out fusing on the downstream side of the image forming unit 11 from the perspective of a direction in which the recording medium 41 is carried. The fuser 30 has a function to fuse and fix the toner image to the recording medium 41 by applying pressure and heat to the transferred developer image on the recording medium 41. The fuser 30 includes a heat roller 31 and a backup roller 33 which have circular tube shapes. The heat roller 31 is formed by coating a surface of an aluminum tube with a fluorocarbon polymer, such as Perfluoro alkoxyl alkane (PFA) and/or Polytetrafluoroethylene (PTFE). A heat source 32 such as a halogen lamp is arranged in the heat roller 31. A power source (not illustrated) applies a bias voltage to the heat source 32. The backup roller 33 includes a surface layer made of an elastic body material. The backup roller 33 contacts the surface of the heat roller 31. When the recording medium 41 passes between the heat roller 31 and the backup roller 33, the developer image is fixed on the recording medium 41.

The eject roller 35 and the pinch roller 36 send the recording medium 41 to a space between the ejection roller 37 and the pinch roller 38 while sandwiching the recording medium 41 fed from the fuser 30. The eject roller 37 and the pinch roller 38 send the recording medium 41 to the stacker part 39 while sandwiching the carried recording medium 41. The stacker part 39 folds and accommodates the recording mediums 41. The backup roller 33, the eject rollers 35 and 37 carry the recording medium 41 by rotating in response to a power transmitted from a drive source (not illustrated) through a power transmission mechanism such as a gear and the like.

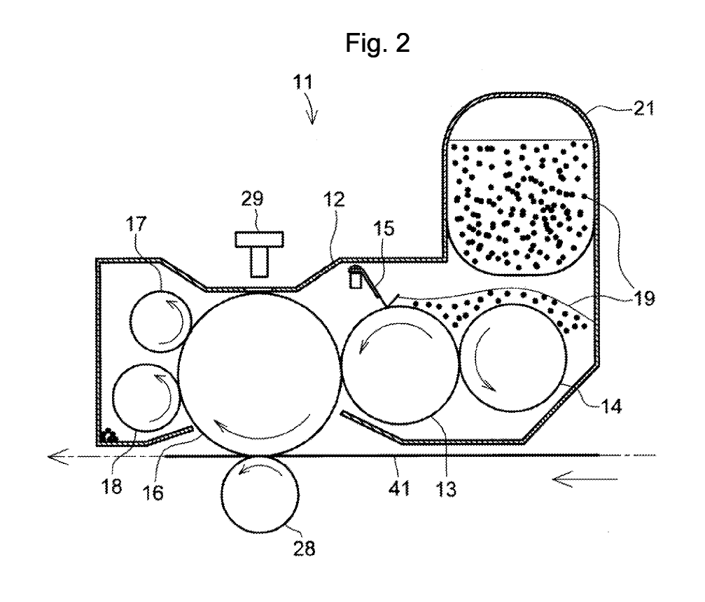

FIG. 2 schematically illustrates a structure of the image forming unit 11 implemented in the image forming apparatus 1. The image forming unit 11 of the present embodiment has a function to perform a single-component development. A toner cartridge 21 (developer container) is removably installed to the image forming unit 11. The toner cartridge 21 contains developer 19. The developer 19 is made of a non-magnetic one-component toner (toner that includes no magnetic material or carrier). The developer cartridge 21 supplies the image forming unit 11 with the developer 19.

As illustrated in FIG. 2, the image forming unit 11 includes a photosensitive drum 16, a charging roller 17, an LED head 29 (exposure part), a development roller 13, a sponge roller 14, a development blade 15 and a cleaning roller 18. The charging roller 17 uniformly charges the surface of the photosensitive drum 16. The LED head 29 exposes the surface of the photosensitive drum 16 to light to form an electrostatic latent image on the surface of the photosensitive drum 16. The development roller 13 is a developer carrier. The sponge roller 14 is a developer supply member. The development blade 15 is a developer layer forming member. The cleaning roller 18 scrapes the developer 19 that remains on the photosensitive drum 16 without being transferred. The photosensitive drum 16 is cylindrical and extends in a longitudinal direction (direction perpendicular to sheet surface) that is perpendicular to the direction in which the recording medium 41 is carried. The charging roller 17, the development roller 13 and the cleaning roller 18 are cylindrical and extend in a longitudinal direction (direction perpendicular to sheet surface) that is perpendicular to the direction in which the recording medium 41 is carried. The charging roller 17, the development roller 13 and the cleaning roller 18 are in contact with the surface of the photosensitive drum 16 in their longitudinal direction. The sponge roller 14 is in contact with the surface of the development roller 13 in the longitudinal direction.

The photosensitive drum 16 is configured by a metal tube of aluminum or the like (conductive base), and a photoconductive layer of organic photosensitive body (OPC) or the like formed around the metal tube, for example. The LED head 29 includes a plurality of LED elements (Light Emitting Diode elements, not illustrated), an LED drive part (not illustrated) that drives the LED elements, and a lens array (not illustrated) that guides light emitted from the LED elements to the surface of the photosensitive drum 16.

The development roller 13 has a function to attach the developer 19 to the electrostatic latent image on the photosensitive drum 16 by contact development. Namely, the development roller 13 attaches the developer 19 to the electrostatic latent image on the photosensitive drum 16 by contact with the surface of the photosensitive drum 16. The development roller 13 is produced, for example, by forming on a conductive shaft an elastic body layer made of semiconductor silicon rubber to which UV light is applied, and then coating a surface of the elastic body layer to form a coat layer of urethane-based resin and a silane coupling agent layer. A thickness of the coat layer can be in the range of 7 μm to 13 μm, for example.

The coat layer of the development roller 13 includes silica particles to have a surface roughness. The surface of the development roller 13 is preferably polished to have the surface roughness Rz in the range of 13 μm to 26 μm in accordance with JIS (Japanese Industrial Standards) B 0601-1994, if necessary. A value of Rz is preferably large to ensure a print density. A resistance value Rv (roller resistance) of the development roller 13 is preferably within the range of 1×10⁸Ω to 5×10⁹Ω. The roller resistance Rv is measured according to the equation R=Vd/I, where Vd denotes a voltage (100 volt) applied between the surface of the development roller 13 and the conductive shaft while contact is made by a force of 20 gf (approximately 0.2N) between the surface of the development roller 13 and an SUS ball bearing having a width of 2.0 mm and a diameter of 6.0 mm; and I is a current measurement value of a current that flows between the surface of the development roller 13 and the conductive shaft when the voltage Vd is applied. Furthermore, a hardness of the development roller 13 is 42±5° in accordance with JIS-A standard.

The sponge roller 14 is configured by a conductive shaft and a semiconductive silicone foam rubber layer formed on the conductive shaft, for example. The sponge roller 14 supplies the developer 19 on the development roller 13. The silicone foam rubber layer is preferably polished to have a predetermined outer diameter. The silicone rubber layer compound is made by adding reinforcing silica fillers, a vulcanizing agent for vulcanization and a foaming agent, to raw rubber such as dimethyl silicone raw rubber and methyl phenyl silicone raw rubber. As the foaming agent, an inorganic foaming agent such as sodium bicarbonate, or an organic foaming agent such as ADCA (amide azodicarboxylate or azodicarbonamide) are used.

In addition, a hardness of the sponge roller 14 is approximately 41° measured by using a durometer (Asker Durometer type F, by Kobunshi Keiki Co., Ltd.), for example. The durometer Asker F includes a pressure foot and an indentor that protrudes from the middle of the pressure foot. The indentor is supported by a spring. Specifically, a value (hardness) is immediately read when the pressure foot of the durometer Asker F falls from a 10 mm height to a target point in the sponge roller 14 at a certain speed, and the pressure foot of the durometer Asker F contacts the surface of the sponge roller 14. Values are read at three points (at two respective points on the sponge roller 14 45 mm from both end parts in an axial direction and a point of the middle in the axial direction). A mean value of the read values is adjusted to 41°. In the image forming apparatus 1, the surface of the sponge roller 14 is pressed 1.0±0.15 mm into the development roller 13. The sponge roller 14 preferably has a roller resistance in the range of 1×10⁶Ω to 1×10⁸Ω when 300 V is applied using the same method as that of the development roller 13.

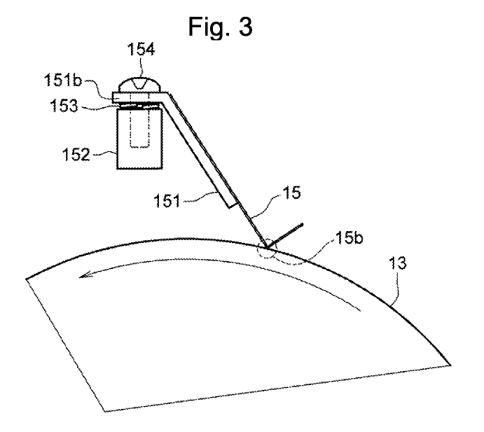

The development blade 15 is configured by a plate shaped member, for example, an SUS material having a thickness of approximately 0.08 mm. The development blade 15 includes a curvature part having a predetermined curvature radius R. The development blade 15 is arranged so that the curvature part abuts on the surface of the development roller 13. FIG. 3 schematically illustrates an arrangement of the development roller 13 and the development blade 15.

As illustrated in FIG. 3, the development blade 15 includes a curvature part 15b having a curvature radius R. The curvature part 15b extends in an axial direction (longitudinal direction) of the development roller 13 and abuts on the surface of the development roller 13 in the axial direction. In addition, a proximal end part of the development blade 15 is fixed to a sheet metal member 151 using a tightening member such as a screw or the like. A proximal end part 151b of the sheet metal member 151 is fastened to a fastening part 152 integrated with the chassis 12 of the image forming unit 11 using an elastic member 153 and a screw 154. Specifically, a shaft part of the screw 154 is inserted into a penetration hole of the proximal end part 151b of the sheet metal member 151 and a center of the annular elastic member 153, and screws into a screw groove of the fastening part 152. Thereby, a head part of the screw 154 tightens the proximal end part 151b of the sheet metal member 151 to the fastening part 152 via the elastic member 153. A pressure that the curvature part 15b of the development blade 15 applies to the surface of the development roller 13 is determined according to a tightening force of the screw 154 and a reaction force of the elastic member 153. Accordingly, a linear pressure (abutting pressure in the axial direction of the development roller 13 per unit length) between the curvature part 15b and the surface of the development roller 13 is adjustable by adjusting the tightening force of the screw 154. Alternatively, the linear pressure is adjustable by arbitrarily selecting the number of elastic members 153 used and/or an elastic proportion of the elastic member 153. An elastic washer (spring washer) may be preferably used as the elastic member 153, for example, but is not limited thereto.

The cleaning roller 18 includes a conductive foam layer that adheres to an outer circumference of a metal core (shaft part) having an outer diameter of φ6 mm with a primer, for example. The conductive foam layer is mainly composed of EPDM (ethylene-propylene-diene rubber). An average foamed cell diameter of the conductive foam layer is in the range from 100 μm to 300 μm, for example. The foamed cell diameter is measurable by using a stereoscopic microscope. A rubber hardness of the conductive foam layer is in the range from 35° to 45°, for example. The rubber hardness is measurable by using a durometer (Asker Durometer type C, by Kobunshi Keiki Co., Ltd.) under a load of 4.9 Newton.

In addition, the cleaning roller 18 abuts on the surface of the photosensitive drum 16 on both end sides of a shaft (shaft part) of the photosensitive drum 16 by a spring elastic force. A resistance value Rv (roller resistance) of the cleaning roller 18 is within the range of 2×10⁶Ω to 2×10⁷Ω. The roller resistance Rv of the cleaning roller 18 is measured according to the equation by R=Vd/I, where Vd denotes a voltage (400 volt) applied between the surface and the shaft part of the cleaning roller 18 while the cleaning roller 18 is pressed 0.25 mm into the drum having an outer diameter of φ30 mm and rotates; and I is a current measurement value of a current that flows when the voltage Vd is applied.

The charging roller 17 includes a conductive, elastic layer as a surface layer. The conductive elastic layer is an ion-conductive elastic rubber layer which is mainly composed of epichlorohydrin rubber (ECO), for example. A surface treatment is performed on a surface of the rubber elastic layer. In the surface treatment, the surface hardens by permeation of a surface treatment solution containing polyisocyanate-based component such as hexamethylene diisocyanate (HDI). Thereby, uncleanliness-resistance of the photosensitive drum 16 and release property of micro particles such as toner particles and the external additives of the toner are ensured. In addition, a hardness of the elastic layer of the charging roller 17 is measured by using the durometer Asker C, and the hardness is 73°. A roller resistance value of the charging roller 17 is approximately 6.3 using a log scale with 10 as the base. The resistance value was obtained when the charging roller 17 and a conductive metal drum is nipped by the same pressure as that on the photosensitive drum 16 to be actually used and a DC voltage 500 V was applied between a shaft (shaft part) of the charging roller 17 and the conductive metal drum. The conductive metal drum has the same outer diameter and roughness as the photosensitive drum 16.

Next, the operation of the image forming apparatus 1 having the structure described above is explained below.

First, when an instruction indicating image formation is input to a control unit (not illustrated) that controls the whole operation of the image forming apparatus 1, a motor of a main body part of the image forming apparatus 1 (not illustrated) starts rotating, and a driving power is transmitted to a drum gear through a plurality of gears in the main body part. Thus, the photosensitive drum 16 rotates. With the rotation of the photosensitive drum 16, a driving power transmission to a development gear from the drum gear causes the development roller 13 to rotate. A driving power transmission to a sponge gear from the development gear through an idle gear causes the sponge roller 14 to rotate. Moreover, a driving power transmission to a charge gear from the drum gear causes the charging roller 17 to rotate, a driving power transmission to a cleaning gear from the drum gear causes the cleaning roller 18 to rotate, and a driving power transmission to a transfer gear from the drum gear causes the transfer roller 28 to rotate. Furthermore, a rotation driving power of the motor in the main body part is transmitted to a heat roller gear through a plurality of gears for another system in the main body part. Thus, the heat roller 31 rotates. The backup roller 33 follows to rotate in accordance with the rotation of the heat roller 31. Rotation directions of the rollers 13, 14, 17 18 and the photosensitive drum 16 are indicated by arrows in FIG. 2.

At substantially the same time as a start of the rotation of the motor described above, a power source in the main body part applies predetermined bias voltages to the development roller 13, the sponge roller 14 and the transfer roller 28 used in developing and transferring, and to the heat source 32 used in transferring, respectively. Next, a bias voltage is applied to the charging roller 17 and the charging roller 17 rotates. Thus, the surface of the photosensitive drum 16 is uniformly charged (e.g., the surface is charged to a potential of −600V). When a charged part of the photosensitive drum 16 reaches under the LED head 29, the LED head 29 emits light according to image data to be printed to expose the surface of the photosensitive drum 16 to the light therefrom. Thereby, the potential of an exposed portion in the surface of the photosensitive drum 16 varies, and an electrostatic latent image on the surface of the photosensitive drum 16 is formed.

A voltage of −300V is applied to the sponge roller 14, and a voltage of −200V is applied to the development roller 13, for example. When the sponge roller 14 supplies the charged developer 19 on the surface of the development roller 13, the developer 19 is thinned by passing at an abutting part between the development roller 13 and the development blade 15. In the meantime, when the electrostatic latent image on the photosensitive drum 16 reaches the development roller 13 with the rotation of the photosensitive drum 16, the thinned developer 19 attaches to the electrostatic latent image due to a difference between the electrostatic latent image (e.g. image having the potential of approximately −20 volt) and the potential of the development roller 13. Thereby, a developer image is formed on the surface of the photosensitive drum 16.

In the transferring, when the recording medium 41 passes a nipping part between the transfer roller 28 and the photosensitive drum 16, the developer image on the photosensitive drum 16 is transferred to the recording medium 41. In the transferring thereafter, when the recording medium 41 passes between the heat roller 31 and the backup roller 33, the developer image is fixed on the recording medium 41 by heat and pressure. In the meantime, the developer 19 that remains on the photosensitive drum 16 without being transferred on the recording medium 41 is scraped by the cleaning roller 18 and collected in accordance with a determined sequence after image forming process is finished.

A pressing parameter Sp is set to be within the range determined by the following equation (1):

9.3×10⁻⁷ g·m²/s²≦Sp≦2.3×10⁻⁶ g·m²/s² (1)

when the pressing parameter Sp (where Sp=π×R²×F) is determined by multiplying a linear pressure F (unit: g/s²) of the curvature part 15b (FIG. 3) of the development blade 15 against the surface of the development roller 13, R² (unit: m), i.e., a square root of the curvature radius R of the curvature part 15b, and pi (π), in the present embodiment.

A process for thinning the layer of the developer 19 between the development blade 15 and the development roller 13 depends not only on the abutting pressure of the development blade 15 on the development roller 13, but also on an elastic deformation shape of the development roller 13 and a size of a contact region between the development blade 15 and the development roller 13. An element parameter π×R² is introduced as an index to evaluate the elastic deformation shape of the development roller 13 and the size of the contact region between the development blade 15 and the development roller 13. As the curvature radius R becomes large, the contact region between the development blade 15 and the development roller 13 enlarges in a circumferential direction (rotational direction) under the condition in which the linear pressure is constant, for example. Thus, the pressure per unit area given by the development blade 15 to the development roller 13 decreases and the elastic deformation shape of the development roller 13 varies.

Stabilization of the process for thinning the layer of the developer 19 is realized by limiting the pressing parameter Sp to the range determined by the equation (1) described above. Accordingly, defects of the image formation are suppressed even if the development blade 15 is used for a long period. Specifically, defects of the printing due to so called “drum fog” or “smudge” are suppressed. Here, “drum fog” means the following phenomenon: developer attaches to a region of the surface of the photosensitive drum 16 in which no electrostatic latent image is formed (region to which developer should not attach essentially). The developer has a lower charge amount than normally charged developer, or is charged in opposite-polarity. “Smudge” means the following phenomenon: developer attaches to a background part of the image formed on the recording medium 41 (i.e., part that corresponds to a region in which no electrostatic latent image is formed). The developer has a higher charge amount than normally charged developer.

A lower limit of the pressing parameter Sp is preferably set to be 1.1×10⁻⁶ g·m²/s² in view of further suppressing the drum fog. In the meantime, an upper limit of the pressing parameter Sp is preferably set to be 2.0×10⁻⁶ g·m²/s² in view of further suppressing the smudge. Preferable ranges of the pressing parameter Sp are discussed later in examples.

The drum fog easily occurs at a high temperature and high humidity environment. A charge amount of toner and fluidity of the developer 19 become low at a high temperature and high humidity environment due to a weak friction force between toner that configures the developer 19. Because of the points described above, a lower limit of an absolute value of a blow-off charge amount of the developer 19 is preferably 20 μC/g, in particular 24 μC/g at a temperature of 22° C. and a relative humidity of 55% to suppress the drum fog at a high temperature and high humidity environment. Preferable ranges of the absolute value of the blow-off charge amount are discussed later in the examples.

In the meantime, the smudge easily occurs at a low temperature and low humidity environment. The charge amount of toner becomes large at a low temperature and low humidity environment due to a strong friction force between toner that configures the developer 19. Because of the points described above, an upper limit of the absolute value of the blow-off charge amount of the developer 19 is preferably 45 μC/g, in particular 37 μC/g at a temperature of 22° C. and a relative humidity of 55% to suppress the smudge at a low temperature and low humidity environment.

The developer 19 of the present embodiment is polymerized toner produced by an emulsion polymerization method. According to the emulsion polymerization method, the polymerized toner is produced: by polymerizing a polymerizable monomer composition mainly composed of a polymerizable monomer containing a precursor of a binder resin in an emulsifier containing a cross-linking agent, a polymerization initiator and the like, thereby producing polymerizable particles; internally adding colorant and wax to the polymerizable particles; and polymerizing the polymerizable particles, colorant and wax. External additives may be added to the polymerized toner, if necessary.

An example of the binder resin used for the polymerized toner is a thermoplastic resin, such as a vinyl resin, a polyamide resin or a polyester resin, for example. Examples of a monomer to form the vinyl resin which is one of the thermoplastic resins are as follows: styrene or styrene derivatives, such as styrene, 2,4-dimethylstyrene, α-methylstyrene, p-ethylstyrene, O-methylstyrene, m-methylstyrene, p-methylstyrene, p-chlorostyrene and vinylnaphthalene; ethylenic monocarboxylic acids and its esters, such as 2-ethylhexyl acrylate, methyl methacrylate, acrylic acid, methyl acrylate, ethyl acrylate, n-propyl acrylate, isobutyl acrylate, t-butyl acrylate, amyl acrylate, cyclohexyl acrylate, n-octyl acrylate, isooctyl acrylate, decyl acrylate, lauryl acrylate, stearyl acrylate, methoxyethyl acrylate, 2-hydroxyethyl acrylate, glycidyl acrylate, phenyl acrylate, α-chloroacrylic acid methyl, methacrylic acid, ethyl methacrylate, n-propyl methacrylate, isopropyl methacrylate, n-butyl methacrylate, isobutyl methacrylate, t-butyl methacrylate, amyl methacrylate, cyclohexyl methacrylate, n-octyl methacrylate, isooctyl methacrylate, decyl methacrylate, lauryl methacrylate, 2-ethylhexyl methacrylate, stearyl methacrylate, methoxyethyl methacrylate, 2-Hydroxyethyl methacrylate, glycidyl methacrylate, phenyl methacrylate, dimethylaminoethyl methacrylate and diethylaminoethyl methacrylate; ethylenically unsaturated monoolefins, such as ethylene, propylene, butylene and isobutylene; vinyl esters, such as vinyl chloride, bromide-vinyl acetate, vinyl propionate, vinyl formate and vinyl caproate; substituted monomers of the ethylenic monocarboxylic acids, such as acrylonitrile, methacrylonitrile and acrylamide; ethylenic dicarboxylic acids and substituted monomers thereof such as maleic ester; vinyl ketones such as vinyl methyl ketone; and vinyl ethers such as vinyl methyl ether.

As the colorant, widely known pigments or dyes corresponding to colors of black, yellow, magenta and cyan can be used, no limitation thereto intended. Carbon black is preferable as a black colorant.

As the cross-linking agent in the emulsion polymerization method, general cross-linking agents can be used: divinylbenzene, divinylnaphtalene, polyethylene glycol dimethacrylate, 2,2′-bis(4-methacryloxy diethoxyphenyl)propane, diethylene glycol diacrylate, triethylene glycol diacrylate, 3-butylene glycol dimethacrylate, 1,6-hexylene glycol dimethacrylate, neopentyl glycol dimethacrylate, dipropylene glycol dimethacrylate, polypropylene glycol dimethacrylate, trimethylolpropane trimethacrylate, trimethylolpropane triacrylate, tetramethylolmethane tetraacrylate and the like. Two or more of these agents can be used in combination, if necessary.

Examples of an inorganic powder added as the external additives are as follows: metal oxides, such as zinc, aluminum, cerium, cobalt, iron, zirconium, chrome, manganese, strontium, tin and antimony; complex metal oxides, such as calcium titanate, magnesium titanate and strontium titanate; metal salts, such as barium sulfate, calcium carbonate, magnesium carbonate and aluminum carbonate; clay minerals, such as kaolin; phosphate compounds, such as apatite; silicon compounds, such as silica, silicon carbide and silicon nitride; and carbon powders, such as carbon black and graphite.

### EXAMPLES

Next, various examples and comparative examples of the image forming unit 11 is explained. The examples are given solely for the purposes of illustration and are not to be construed as limitations of the present invention.

[Configurations of Development Roller and Development Blade for Evaluation]

The development roller 13 for evaluation used in the examples and the comparative examples was configured by a conductive shaft, an elastic body layer (semiconductor silicon rubber layer to which UV light treatment is performed) formed on the conductive shaft, a coat layer made of polyurethane resin coating on an outer circumferential surface of the elastic body layer and a layer including silane coupling agent coating on the coat layer. The surface of the development roller 13 was adjusted to have the surface roughness Rz of 20 μm in accordance with JIS (Japanese Industrial Standards) B 0601-1994.

In the meantime, the development blade 15 for evaluation was configured by an SUS material having a thickness of 0.08 mm. In addition, nine blades B-1 to B-9 (described below) as the development blades 15 for evaluation that include a curvature part 15b having a curvature radius R were prepared. The curvature radii R of the blades were different from each other.
Blade B-1:R=2.50×10⁻⁴ m
Blade B-2:R=2.60×10⁻⁴ m
Blade B-3:R=2.75×10⁻⁴ m
Blade B-4:R=2.90×10⁻⁴ m
Blade B-5:R=3.00×10⁻⁴ m
Blade B-6:R=3.10×10⁻⁴ m
Blade B-7:R=3.25×10⁻⁴ m
Blade B-8:R=3.40×10⁻⁴ m
Blade B-9:R=3.50×10⁻⁴ m

Here, the curvature radius R was obtained based on measurement results measured by measuring a contour shape along an outer surface of the curvature part 15b of the development blade 15 at a scan speed of 0.02 mm/s with the surfcorder SEF3500 (contour measuring instrument, by Kosaka Laboratory, Ltd.). The surface of the development roller 13 had a ten-point average roughness Rz of 0.6 μm.

As illustrated in FIG. 3, the development blade 15 was fixed to the fastening part 152a using the sheet metal member 151, the elastic member 153 and the screw 154. An elastic washer or a plurality of elastic washer was used as the elastic member 153.

[Developer for Evaluation]

The developer 19 used in the examples and the comparative example was polymerized toner produced by the emulsion polymerization method. According to the emulsion polymerization method, the polymerized toner was produced by mixing a styrene-acrylic copolymer resin, a black colorant and wax; forming toner particles before addition of external additives as a result of aggregation of the mixture; and mixing the toner particles before addition of external additives and fine powders of silica and titanium oxide by using a mixer. More specifically, primary particles of a polymer as blinding resin for the toner before addition of external additives were produced in water solvent. Colorant emulsified by an emulsifier (surface active agent) was mixed into the solvent in which the primary particles were dissolved. Wax, charge control agent and the like were mixed, if necessary. The toner particles before addition of external additives were produced by aggregating the mixture in the solvent. The toner particles before addition of external additives were extracted from the solvent. Unnecessary solvent component and by-product component were removed from the toner particles before addition of external additives by cleaning and drying. In the examples and comparative examples, the styrene-acrylic copolymer resin was produced from styrene, acrylic acid and methyl methacrylate. A carbon black was used as the colorant and stearyl stearate (higher fatty acid ester wax) was used as the wax.

According to the method described above, the toner particles before addition of external additives thus obtained has a mean particle diameter of 7.0 μm. The mean particle diameter of the obtained toner particles before addition of external additives was determined from a measurement by using a cell counter and analyzer “Coulter Multisizer 3” (by Beckman Coulter, Inc.) In the measurement, an aperture diameter was 100 μm and the number of counts was 30000. Circularity was measured by using a flow particle image analyzer FPIA-2100 (by Sysmex Corporation) according to the following equation (2):

circularity=L1/L2, (2)

where L1 is a perimeter of a circle having the same area as that of a particle projected image, and L2 is a perimeter of the particle projected image. If a particle has a circularity of 1.00, the shape of the particle is perfectly spherical. When a circularity is less than 1.00, the less the circularity becomes, the particle shape becomes more indefinite.

A mean circularity for ten toner particles before addition of external additives was calculated, and the calculated value of 0.97 was yielded.

Toner for evaluation was obtained by adding 1.8 parts by weight of Aerosil RX50 (by Nippon Aerosil Co., Ltd.) to 100 parts by weight of the toner particles before addition of external additives, and mixing them for 25 minutes.

[Procedure of First Experiment (Durability Test)]

As illustrated in FIG. 3, the development blade 15 was arranged so that a center (base point) of the surface of the curvature part 15b abutted on the surface of the development roller 13. In addition, the blades B-1 to B-9 as the development blades 15 were fastened in the image forming unit 11 in order. In addition, a linear pressure F of each of the fastened blades B-1 to B-9 was varied by adjusting the number of the elastic members 153 (washers). A relative distance between the development blade 15 and the development roller 13 was adjusted by adjusting the number of the elastic members. Thereby, a distance between a fulcrum and a load of the development blade 15 was adjusted to vary the linear pressure F in the range of 2.9 to 7.8 g/s². The image forming unit 11 was filled with the toner particles for evaluation described above as the developer 19.

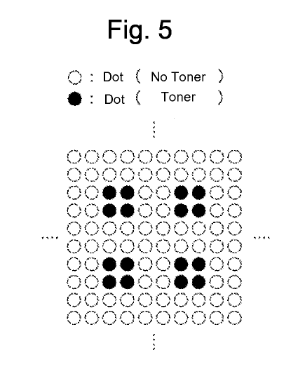

Printing onto the recording medium 41 was performed at the normal temperature and humidity environment (temperature of 22° C., relative humidity of 55%, hereinafter referred to as NN environment). Specifically, a 1.25% duty image was printed on a sheet of standard letter size (e.g., paper of Xerox 4200; 92 brightness; and 20 Lb basis weight) fed in a portrait orientation (the two shorter sides out of the four sides of the sheet being a leading edge and a trailing edge). Here, a white sheet and a sheet including a 2×2 image test pattern was printed every 1000 sheets printing. The 1.25% duty image meant an image with a 1.25% black-colored area. A 100% duty image was an image with a 100% black colored area. In addition, as illustrated in FIG. 5, the 2×2 image having a print density of 600 dpi was an image obtained by repeatedly printing 2×2 unit dot images and 2×2 unit dot white parts in the horizontal direction and in the vertical direction. In the 2×2 image, the printed area takes up 25% of the entire recording medium.

Then, the image forming apparatus 1 was turned off during the printing of the white sheet, and drum fogs (hereinafter, also referred to as “fog”) were measured. Specifically, the image forming unit 11 was removed from the image forming apparatus 1. A transparent mending tape (by Sumitomo 3M Limited) was attached detachably to the surface of the photosensitive drum 16 for the purpose of removing the developer that attaches to the photosensitive drum 16. Thereafter, the tape was removed. And then, the detached tape was attached to a white sheet. Another piece of the mending tape (by Sumitomo 3M Limited) with no attachment was attached to the white sheet in advance for comparison. An average of color differences ΔE (average of differences of for similar five points) on the mending tape detached from the photosensitive drum 16 was measured by using a spectrophotometer “CM-2600d” by Konica Minolta (measurement aperture φ810 mm).

The color difference ΔE is determined by the following equation (3):

ΔE=[(L₁−L₂)²+(a₁−a₂)²+(b₁−b₂)²]^{1/2} (3)

where L₁, a₁ and b₁ represent lightness (L₁) and chromaticities (a₁, b₁) of the mending tape detached from the photosensitive drum 16, respectively; and L₂, a₂ and b₂ represent lightness (L₂) and chromaticities (a₂, b₂) of the mending tape itself with no attachment, respectively.

The image forming apparatus 1 was allowed to continue to print up to 10000 sheets unless defects of printing (smudge, drum fog) were found. The defects of printing were determined according to references described below.

The image quality for the drum fog was judged according to the references described below:
⊚ (extremely good): ΔE less than 3.0,
◯ (good): ΔE of 3.0 or more and less than 5.0,
× (poor): ΔE of 5.0 or more.

As discussed above, the drum fog occurs when developer that has a comparatively lower charge amount or is charged in opposite-polarity attaches to a region of the surface of the photosensitive drum 16 in which no electrostatic latent image is formed. The surface of the photosensitive drum 16 is charged with negative electric charges by the charging roller 17. When the LED head 29 exposes the surface of the photosensitive drum 16 to light, charges in the exposed parts disappear, and a potential of the exposed parts becomes approximately 0 volts. Therefore, when developer has appropriate charge amount and is normally and negatively charged, the developer attaches to the exposed parts and forms a developer image. However, when the developer that has an extremely lower charge amount than normally charged developer or is charged in opposite-polarity exists, the developer attaches to a non-exposed part of the photosensitive drum 16 that has a negative potential. Thereby, the drum fog occurs. When the drum fog occurs, the developer attaches to a non-printed area of the recording medium 41 not to be printed essentially, and the development is performed.

The index ΔE of the drum fog equal to 5.0 or more indicates that the image quality was poor (represented by “×”) since gray in the printed white sheet was obvious. The index ΔE of the drum fog less than 3.0 indicates that the image quality was extremely good (represented by “⊚”) since the printed white sheet could not be distinguished from a white sheet on which nothing was printed.

The image quality for the smudge was judged as follows:
⊚ (extremely good): nothing was printed in a non-printing area and the 2×2 image was evenly printed,
◯ (good): nothing was printed in a non-printing area and the 2×2 image includes a deep portion,
× (poor): the toner was printed in a non-printing area where smudge exists.

Here, as discussed above, the smudge occurs when developer that is extremely charged attaches to a non-printed area of the recording medium 41. When the developer has an extreme charge amount, a toner potential (i.e., surface potential of a thinned developer layer) on the development roller 13 becomes large in a negative side with respect to the surface potential of the photosensitive drum 16, and an amount of the developer that moves from the development roller 13 onto the photosensitive drum 16 increases. As a result, the developer attaches to a non-printed area of the recording medium 41, and the non-printed area is developed.

[Evaluation Results of First Experiment]

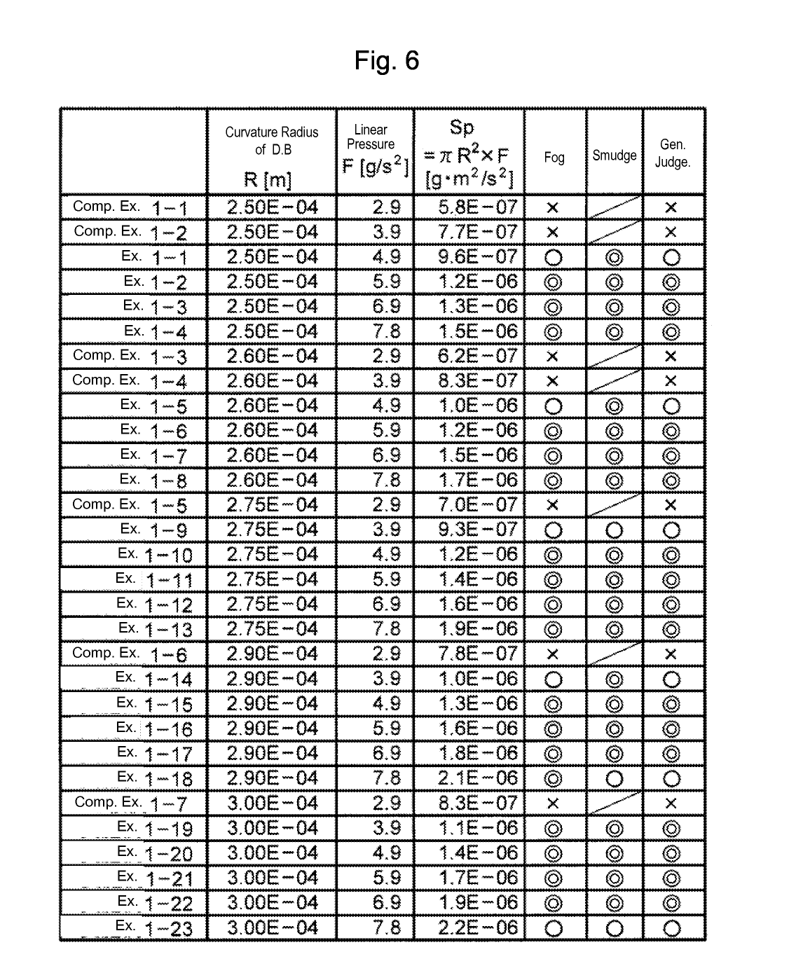

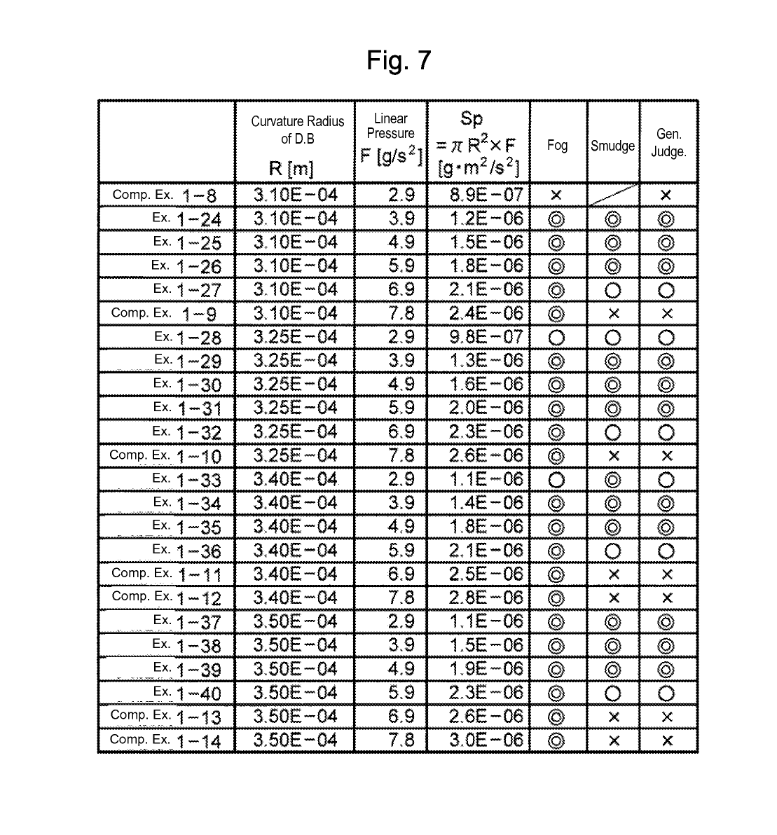

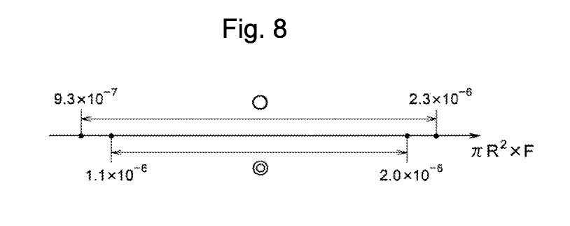

FIGS. 6 and 7 illustrate values of the pressing parameter Sp and the evaluation results of the first experiment of the examples 1-1 to 1-40 and the comparative examples 1-1 to 1-14. Values of the curvature radius R and the pressing parameter Sp are determined in the format: “pE-q” (p: real number, q: integer), which means p×10^{-q}. According to FIGS. 6 and 7, as illustrated in FIG. 8, when the pressing parameter Sp is within the range of 9.3×10⁻⁷ g·m²/s² or more to 2.3×10⁻⁶ g·m²/s² or less, no defects such as smudge or fog occurred, and favorable printing (represented by “◯”) continued to be performed even when the number of pages printed reached 10000.

In the meantime, when the pressing parameter Sp was less than 9.3×10⁻⁷ g·m²/s², a region between the curvature part 15b of the development blade 15 and the development roller 13 gave a small frictional force to the toner. Therefore, the charge amount of the toner was insufficient for appropriate printing, and occurrence of the fog was observed at the initial printing stage. When an evaluation regarding fog at the initial printing stage was poor in an experiment, the experiment was stopped.

On the other hand, when the pressing parameter Sp exceeds 2.3×10⁻⁶ g·m²/s², the charge amount of the toner was excessive while the present experiment (durability test) was performed, and occurrence of smudge was observed. The region between the curvature part 15b of the development blade 15 and the development roller 13 gave a large frictional force to the toner.

Furthermore, according to FIGS. 6 and 7, as illustrated in FIG. 8, when the pressing parameter Sp is within a range of 1.1×10⁻⁶ g·m²/s² or more and 2.0×10⁻⁶ g·m²/s² or less, evaluations for both of the drum fog and the smudge were extremely good (represented by “⊚”), and general judgments were extremely good (represented by “⊚”). The region between the curvature part 15b of the development blade 15 and the development roller 13 gave an optimized frictional force to the toner, and the appropriated charge amount of the toner was kept, which contributed to favorable image formation.

[Procedure of Second Experiment]

A second experiment was performed under four experiment conditions in which no smudge or drum fog occurred in the first experiment described above. The four experiment conditions were pressing parameters Sp of 9.3×10⁻⁷ g·m²/s², 1.1×10⁻⁶ g·m²/s², 2.0×10⁻⁶ g·m²/s² and 2.3×10⁻⁶ g·m²/s².

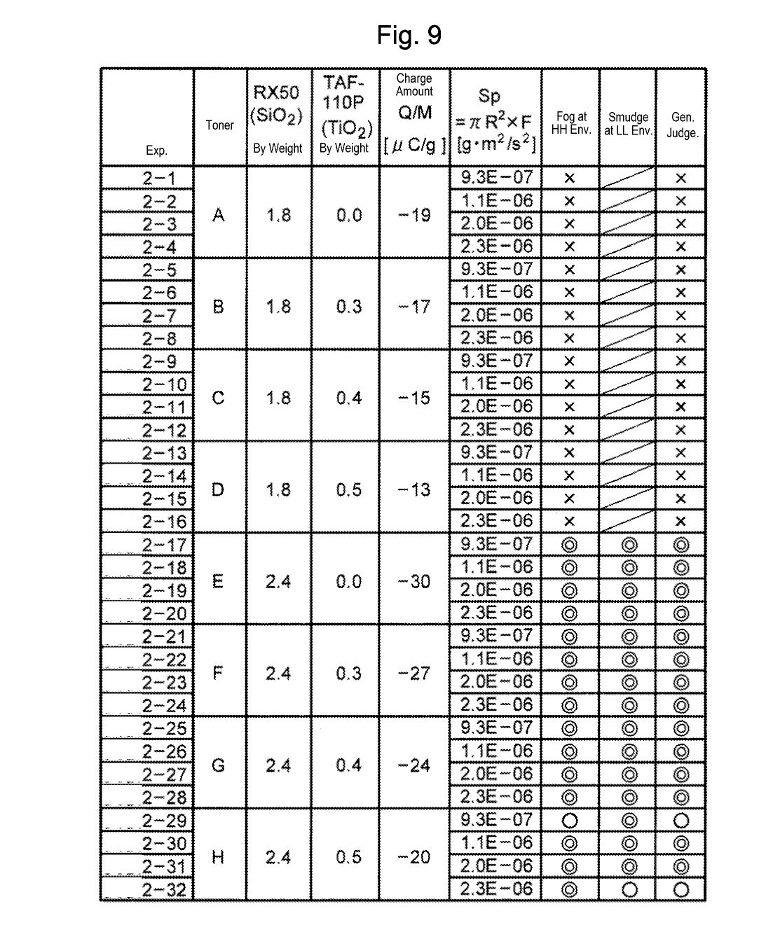

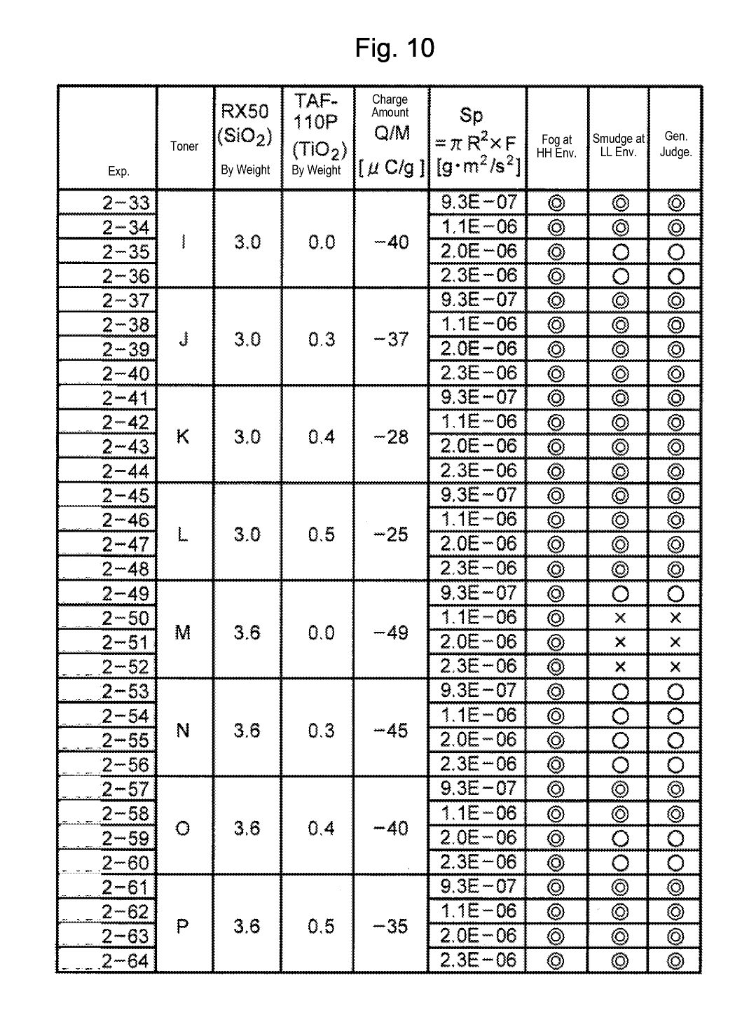

The developer 19 used in the second experiment was 16 toner A to P. The toner was produced by externally adding external additives “Aerosil RX50” (by Nippon Aerosil Co., Ltd.) and “TAF-110P” (titanium oxide, Fuji Titanium Industry Co., Ltd.) to toner particles before addition of external additives for evaluation used in the first experiment described above. The addition amounts of the external additives were varied from those of the first experiment. FIGS. 9 and 10 illustrates the addition amounts (blend amounts) of “Aerosil RX50” and “TAF-110P” in the toner A to P.

In addition, the blow-off charge amount was varied. Durability tests similar to those of the first experiment described above were carried out at each of a high humidity environment (temperature of 28° C. and relative humidity of 80%, hereinafter referred to as HH environment) and a low temperature and low humidity environment (temperature of 10° C. and a relative humidity of 20%, herein after referred to as LL environment). The results of the durability tests were evaluated.

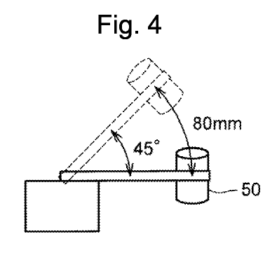

The measurement for the blow-off charge of toner was carried out by using a blow-off charge measurement apparatus “TB-203” (by KYOCERA Chemical Corporation) at the NN environment. Specifically, “F-60” (by Powder Tech Co., Ltd.) was used as a carrier. The toner and the carrier were mixed in a proportion of toner:carrier=1:19 to produce a sample. A shaker “Model YS-LD” (by Yayoi Co., Ltd) was used to shake. As illustrated in FIG. 4, a sample bottle 50 fastened to a front edge part of an arm is set at a horizontal position in an initial state. And then, the shaker shook the sample bottle 50 for 30 minutes under following conditions: a shaking frequency of 200 times per minute, a shake angle of 0 degrees to 45 degrees, and a shake width of 80 mm, and mixed the toner and the carrier. After that, the sample was put in a container of the blow-off charge measurement apparatus that includes an SUS-316 wire mesh of 400 MESH (a wire mesh designated for powder charge measurement by Kyocera). And then, the blow-off charge measurement apparatus performed a suction operation for 10 seconds under following conditions: a blow pressure of 7 kPa and a suction pressure of 4.5 kPa. Thus, an electric charge amount Q/M (unit: μC/g) of the toner particle per unit weight was calculated from an electric charge amount and a suction amount obtained after 10 seconds.

Generally, the drum fog easily occurs at an HH humidity environment since the charge amount of toner becomes low due to a weak friction force between toner. In the meantime, the smudge easily occurs at an LL environment since the charge amount of toner becomes large due to a strong friction force between toner. Therefore, in a second experiment (durability test), when an evaluation regarding the drum fog at the initial printing stage at the HH environment was good (represented by “◯”) in an experiment, the experiment at the LL environment was continued to be carried out, and smudge was evaluated.

[Evaluation Results of Second Experiment]

FIGS. 9 and 10 illustrate blow-off charge amounts Q/M measured in the second experiment (durability test) and evaluation results regarding the blow-off charge amounts Q/M. As illustrated in FIG. 9, evaluations regarding fog at the HH environment were poor (represented by “×”) in experiments in which all of the toner A to D was used. Absolute values of blow-off charge amounts of all of the toner A to D were less than 20 μC/g. Developer being charged in opposite-polarity increased when an absolute value of a blow-off charge amount was less than 20 μC/g. In the meantime, as illustrated in FIG. 10, an evaluation regarding the smudge was poor (represented by “×”) as a result of the durability test at the LL environment in an experiment in which toner M was used. The smudge was generated when an absolute value of a blow-off charge amount was 49 μC/g, which was large.

The maximum absolute value of the blow-off charge amount was the blow-off charge amount of toner N of 45 μC/g among absolute values of the blow-off charge amounts in which no smudge was generated at the LL environment. According to FIGS. 9 and 10, the lower limit of the absolute value of the blow-off charge amount is preferably 20 μC/g when the pressing parameter Sp is within the range of 9.3×10⁻⁷ g·m²/s² to 2.3×10⁻⁶ g·m²/s². In addition, an upper limit of the absolute value of the blow-off charge amount is preferably 45 μC/g to suppress the smudge. Accordingly, the absolute value of the blow-off charge amount is preferably within a range of 20 μC/g to 45 μC/g to achieve favorable printing without fog or smudge at the HH and LL environments.

With reference to FIGS. 9 and 10, in particular, when the absolute value of the blow-off charge amount is within a range of 24 μC/g and more to 37 μC/g or less, all of the evaluations regarding fog and smudge were extremely good (represented by “⊚”). According to the results described above, the absolute value of the blow-off charge amount is preferably within the range of 24 μC/g and more to 37 μC/g or less, in particular.

In the foregoing specification, the present invention has been described with reference to specific embodiments thereof. It will, however, be evident that various modifications and changes can be made to the specific embodiments without departing from the broader spirit and scope of the invention as set forth in the appended claims. For example, in the specific embodiments, the image forming unit 11 has a function to form a black developer image. However, the present invention is not limited thereto. A configuration of the image forming unit 11 may arbitrarily be changed to form a developer image in colors other than black.

In addition, the image forming apparatus 1 described above mounts the sole image forming unit 11. However, the present invention is not limited thereto. A color image forming apparatus that includes the same configuration as the image forming unit 11 and mounts a plurality of image forming units that form a developer image in different colors from black may be configured.

In addition, the developer 19 of the embodiment described above is polymerized toner. However, the present invention is not limited thereto. Developer may be produced by a pulverization method. Furthermore, the image forming apparatus 1 of the embodiment described above uses non-magnetic single-component developer 19, and may use two-component developer including carriers and toner.

The image forming apparatus 1 described above may be incorporated into a photocopy apparatus and a facsimile device.

What is claimed is:

1. An image forming unit, comprising:
an image carrier configured to carry an electrostatic latent image on a surface thereof;
a developer supply member configured to supply developer;
a developer carrier configured to carry the developer supplied by the developer supply member on a surface thereof; and
a developer layer forming member that includes a curvature part having a predetermined curvature radius, configured to abut the curvature part on the surface of the developer carrier to form a developer layer on the surface of the developer carrier, wherein
the developer carrier attaches the developer layer to the electrostatic latent image to form a developer image on the surface of the image carrier,
a pressing parameter is set to be within a range of 9.3×10⁻⁷ g·m²/s² or more and 2.3×10⁻⁶ g·m²/s² or less when the pressing parameter is determined by multiplying a linear pressure of the curvature part against the surface of the developer carrier, a square root of the curvature radius, and pi (π).

2. The image forming unit of claim 1, wherein
a lower limit of the pressing parameter is 1.1×10⁻⁶ g·m²/s².

3. The image forming unit of claim 1, wherein
an upper limit of the pressing parameter is 2.0×10⁻⁶ g·m²/s².

4. The image forming unit of claim 1, wherein
the pressing parameter is within a range of 1.1×10⁻⁶ g·m²/s² or more and 2.0×10⁻⁶ g·m²/s² or less.

5. The image forming unit of claim 1, wherein
a lower limit of an absolute value of a blow-off charge amount of the developer is 20 μC/g at an environment with a temperature of 22° C. and a relative humidity of 55%.

6. The image forming unit of claim 1, wherein
an upper limit of an absolute value of a blow-off charge amount of the developer is 45 μC/g at an environment with a temperature of 22° C. and a relative humidity of 55%.

7. The image forming unit of claim 1, wherein
an absolute value of a blow-off charge amount of the developer is within a range of 20 μC/g or more and 45 μC/g or less at an environment with a temperature of 22° C. and a relative humidity of 55%.

8. The image forming unit of claim 7, wherein
an absolute value of a blow-off charge amount of the developer is within a range of 24 μC/g or more and 37 μC/g or less at an environment with a temperature of 22° C. and a relative humidity of 55%.

9. The image forming unit of claim 1, wherein
the developer is produced by an emulsion polymerization method.

10. An image forming apparatus, comprising:
the image forming unit of claim 1; and
a transfer member configured to transfer the developer image formed by the image forming unit onto a recording medium.
